(19) United States
(12) Patent Application Publication
(10) Pub. No.: US 2005/0110223 A1
(43) Pub. Date: May 26, 2005

(54) Cylinder-head gasket comprising an edge-to-edge stop ring which is connected by means of stapling

(76) Inventor: Michel Pepin, Gamard (FR)

Correspondence Address: HARNESS, DICKEY & PIERCE, P.L.C., P.O. BOX 828, BLOOMFIELD HILLS, MI, 48303, US

(21) Appl. No.: 10/490,775

(22) PCT Filed: Sep. 25, 2002
(86) PCT No.: PCT/FR02/03270

(30) Foreign Application Priority Data
Sep. 28, 2001 (FR) 01/12492

(51) Int. Cl. F02F 11/00

(52) U.S. Cl. 277/598; 277/592

(57) ABSTRACT

A cylinder head gasket comprising an edge-to-edge stopper with a stopper/support sheet connection that provides better support for the stopper and does not create excessive stresses.

### CROSS-REFERENCE TO RELATED APPLICATIONS

This application is a National Stage of International Application No. PCT/FR02/03270, filed Sep. 25, 2002. This application claims the benefit of French Patent Application 01/12492, filed Sep. 28, 2001. The disclosures of the above applications are incorporated herein by reference.

### FIELD OF THE INVENTION

The present invention relates to a cylinder head gasket comprising an edge-to-edge stopper characterized more particularly by the mode of connection of the stopper to the remainder of the gasket.

### BACKGROUND OF THE INVENTION

A cylinder head gasket comprises two sheets with at least one opening corresponding to the opening of a combustion chamber. At least one of the two sheets, and preferably both, comprise a rib disposed around each opening at a distance from the edge of the opening, wherein the ribs are deformed toward the interior of the gasket.

In addition, the gasket comprises an intermediate support sheet interposed between the two external sheets and opposite the ribs, as well as a stopper in the form of an annular lining that has an internal diameter that approximately corresponds to the diameter of the opening. An external diameter of the stopper is smaller than that of the ribs. The stopper is disposed from edge to edge along the extension of the support sheet.

The connection between the stopper and the support sheet is generally obtained by welding, gluing or the like. French patent application FR-00.12669, filed in the name of Applicant, proposes a method of connecting the stopper to its support sheet by a radial expansion of the stopper. This method, however, is difficult to implement because it causes deformation of the entire stopper.

### SUMMARY OF THE INVENTION

The present invention proposes a novel cylinder head gasket comprising an edge-to-edge stopper with a novel stopper/support sheet connection that provides better support for the stopper, and does not create excessive stresses at the level of the latter.

To this end, the present invention provides a cylinder head gasket with at least one opening that corresponds to a combustion chamber. In one embodiment of the invention, at least one sheet, referred to as external, comprises a circular rib that surrounds the opening. The sheet is disposed a distance from the edge of the opening. In another embodiment, a support sheet is disposed against the face of the external sheet that bears the projecting rib. The support sheet comprises an opening with a diameter that is greater than the opening of the external sheet so as to define a space wherein a stopper is disposed in the form of an annular lining. The stopper has an internal diameter that corresponds to the opening and an external diameter that is approximately adjusted to the opening of the support sheet so as to be disposed from edge to edge. The connection between the stopper and the support sheet comprises at least one projecting part arranged on either one of the two elements and is disposed in a hollow cutout that has an approximately cooperating shape arranged at the level of the other element. The projecting part has anti-stripping shapes as well as at least one plastic deformation close to the projecting part or parts so as to create a slight expansion, ensuring a connection between the two elements by wedging.

Due to the anti-stripping shapes, wedging stresses only exist locally and do not bring about excessive deformations of the sheet.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of a part of the cylinder head gasket in a plane parallel to the sheets, according to a principle of the present invention;

FIG. 2 is a cross-sectional view of a part of the cylinder head gasket in a plane parallel to the sheets, according to another principle of the present invention;

FIG. 3 is a cross-sectional view of a part of a cylinder head gasket in a plane parallel to the sheets according to yet another principle of the present invention;

FIG. 4 is a cross-sectional view of a part of a cylinder head gasket in a plane parallel to the sheets according to a principle of the present invention;

FIGS. 5A and 5B are cross-sectional views along two different radii of the cylinder head gasket of FIG. 4; and

FIGS. 6A to 6C are top views of different principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

The figures show a cylinder head gasket 10 comprising at least one external sheet 12 and preferably two, as illustrated in FIGS. 5A and 5B, with at least one opening 14 that corresponds to a combustion chamber of an engine block. At least one of the external sheets 12, and preferably both, comprises a circular rib 16 that surrounds the opening 14 and is disposed a distance from the edge of opening 14. The rib or ribs are preferably deformed toward the interior of the gasket.

In a known manner, the intermediate support sheet 18 is interposed between the external sheets 12. In the case where the gasket has only one external sheet 12, the support sheet 18 is disposed against the face of the external sheet 12 bearing the projecting rib 16.

The support sheet comprises an opening that is concentric with the opening 14 of the external sheet or sheets 12, and has a diameter that is greater than the opening 14 so as to define a space wherein a stopper 20 is disposed in the form of an annular lining that has an internal diameter that corresponds to that of the opening 14, and an external diameter that is approximately adjusted to the opening of the support sheet.

Advantageously, the stopper comprises at least one zone of thickness X1 that is greater than a thickness X2 of the support sheet so as to constitute a limiter against the crushing of the ribs, a first barrier of tightness, and to permit the arching of at least one external sheet so as to limit the deflections of the latter during operation.

Depending on the case, the external diameter of stopper 20 can be smaller than that of ribs 16 so that the support sheet 18 fits between the ribs 16, or it can be greater than that of ribs 16 so that a zone of the stopper with a thickness less than X1 fits between ribs 16, as illustrated in FIGS. 5A and 5B.

According to the invention, as illustrated by the drawings, the connection between stopper 20 and intermediate support sheet 16 is obtained with the aid of at least one projecting part 22, which is arranged on either one of the two elements, for example on support sheet 18, and is disposed in a hollow cutout of an approximately cooperating shape at the level of the other element, for example stopper 20. The projecting part has anti-stripping shapes 24, as well as at least one plastic deformation 26 near said projecting part 22 so as to create a slight expansion, ensuring the connection between the two elements by wedging.

An anti-stripping shape means that the projecting part is provided with a reduced cross-section at its foot (zone of junction with the element that supports it).

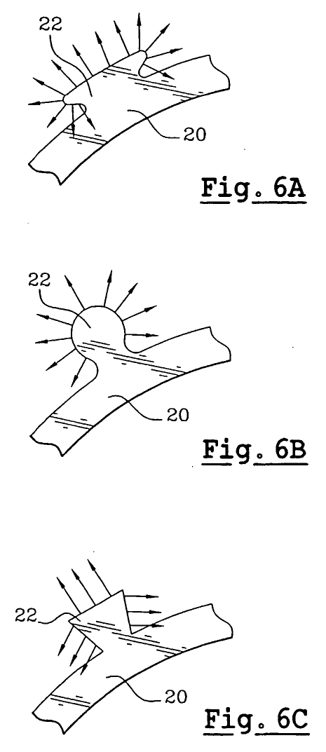

As can be seen from FIGS. 6A to 6C, the wedging stresses arise only locally during plastic deformation and do not create excessive deformations of the sheet and/or the stopper.

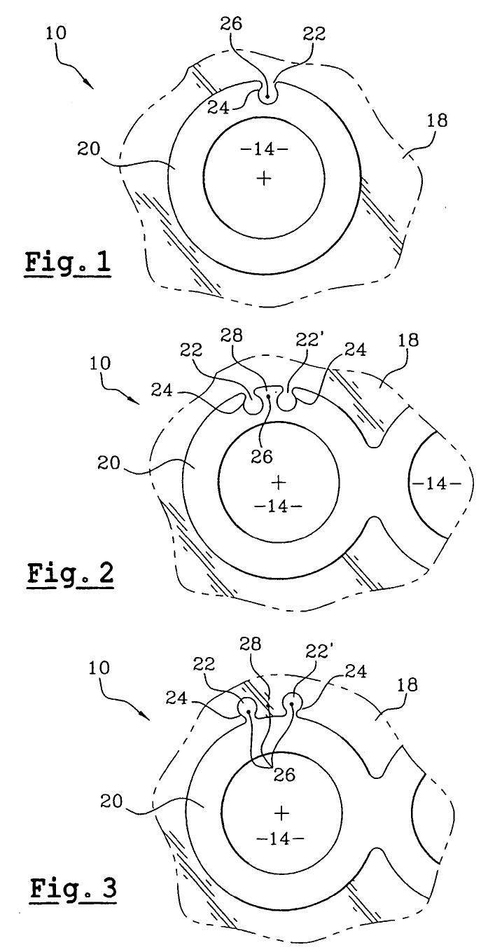

In FIGS. 1 and 2, the projecting part or parts 22 are provided at a level portion of the intermediate sheet 18.

FIG. 3 illustrates an embodiment in which the projecting part or parts 22 are provided at a level portion of the stopper 20.

Depending on the case, the projecting part 22 is in the form of a notch with rounded edges, or it comprises a circumference with a succession of segments. FIGS. 6A and 6B illustrate the different embodiments in a non-exhaustive manner.

Preferably, plastic deformation 26, which can be seen in FIGS. 5A and 5B, is obtained by punching at the level of the projecting part. The punching is in the form of points, or in linear or level form.

According to another embodiment, the connection comprises at least two projecting parts 22, 22′ that are arranged on a first element, namely on either support sheet 18 or stopper 20, or preferably on an intermediate part 28 of the second element. The stopper 20 or support sheet 18, disposed between the two parts, undergoes a plastic deformation so as to create a radial expansion that ensures the connection of the two elements by wedging. Depending on the case, the two projecting parts 22 and 22′, or only the intermediate parts 28, comprise anti-stripping shapes.

In a different variant, the plastic deformation or deformations 26 are produced at the level of the projecting parts.

In the case where there is a multiplicity of projecting parts 22, at least one plastic deformation and preferably several of them can be provided on either the projecting parts 22 and/or the intermediate parts 28.

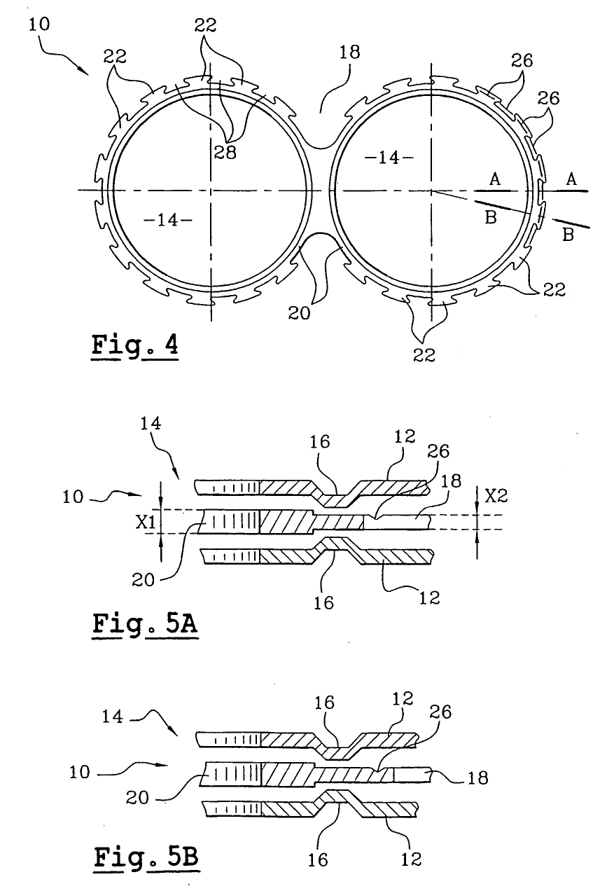

FIG. 4 illustrates a preferred embodiment in which the projecting part or parts have particular shapes.

In this case, the projecting part or parts 22 have an elongated shape with a connection in the form of a narrow strip. This shape makes it possible to increase the contact surface between stopper 20 and support sheet 18 and, by plastic deformation, to obtain a more resistant connection.

Regardless of the shape of the projecting parts 22, the parts are preferably spaced regularly, and the intermediate parts 28 have a profile that is approximately identical to that of projecting parts 22.

It will be understood that the invention is obviously not limited to the embodiments represented and described hereinabove, but that, on the contrary, it covers all variants particularly in regard to the materials used, the shapes of the active part of the stopper and the number of external sheets.

Moreover, the different sheets 12, 18 and the stopper 20 can each consist of a single sheet or of a stack of sheets.

Moreover, the means of connection between the stopper and the support sheet can apply to a single stopper as well as, in the case of a multicylinder gasket, to a group of stoppers connected to each other by a narrow strip.

Finally, the zone of contact between the stopper and the intermediate support sheet can comprise an orifice for the passage of fluid, for example water or oil.

The description of the invention is merely exemplary in nature and, thus, variations that do not depart from the gist of the invention are intended to be within the scope of the invention. Such variations are not to be regarded as a departure from the spirit and scope of the invention.

1. A cylinder head gasket with at least one opening corresponding to a combustion chamber, comprising:
at least one external sheet including a circular rib that surrounds the opening and is disposed at a distance from said opening;
a support sheet disposed against the face of the external sheets that includes the circular rib, the support sheet including another opening with a diameter greater than the opening of the external sheet so as to define a space; and
a stopper disposed in the space in the form of an annular lining, the stopper having an internal diameter that corresponds to that of the opening and an external diameter that is adjusted to the opening of the support sheet so as to be disposed from edge to edge;
wherein a connection between the stopper and the support sheet contains at least one projecting part that is arranged on either the stopper or the support sheet, the projecting part being disposed in a hollow cutout in the form of a cooperating shape that is formed in either the stopper or the support sheet; and
the projecting part of having anti-stripping shapes and at least one plastic deformation near the projecting part so as to create a slight expansion that ensures the connection between the stopper and the support sheet by wedging.

2. The cylinder head gasket according to claim 1, wherein the plastic deformation is created at the projecting part.

3. The cylinder head gasket according to claim 1, wherein the connection between the stopper and the support sheet contains at least two projecting parts arranged on a first element as well as a plastic deformation at an intermediate part of a second element and disposed between the two projecting parts so as to generate a radial expansion ensuring the connection between the two elements by wedging.

4. The cylinder head gasket according to claim 3, wherein the plastic deformation or deformations are also provided at the level of the projecting part or parts.

5. The cylinder head gasket according to claim 1, wherein the plastic deformation or deformations are obtained by punching.

6. The cylinder head gasket according to claim 1, wherein the projecting parts are spaced regularly.

7. The cylinder head gasket according to claim 6, wherein the intermediate parts have a profile that is approximately identical to that of the projecting parts.

8. The cylinder head gasket according to claim 1, wherein the projecting part or parts have an elongated shape, the cross-section at a foot of the projecting part being thinner than at the end thereof.
